(19) United States
(12) Patent Application Publication
(10) Pub. No.: US 2014/0306426 A1
(43) Pub. Date: Oct. 16, 2014

(54) STEERING LINKAGE ARRANGEMENT FOR ARTICULATED MOBILE MACHINE

(71) Applicant: CATERPILLAR INC., Peoai, IL (US)

(72) Inventors: Marcus John GUETHLE, Oswego, IL (US); Steven Denis SPRINGER, North Aurora, IL (US); Joel Patrick BUSKER, Plainfield, IL (US)

(73) Assignee: Caterpillar Inc., Peoai, IL (US)

(21) Appl. No.: 13/862,114

(22) Filed: Apr. 12, 2013

(51) Int. Cl. B62D 13/02

(52) U.S. Cl. CPC B62D 13/025
USPC 280/442

(57) ABSTRACT

A front frame is disclosed for an articulated machine. The front frame may have a central tilt structure with parallel plates, a web member disposed between and connecting the parallel plates, and a hinge component connected to the web member. The front frame may also have mounting lugs connected to the web member opposite the base, the mounting lugs being configured to receive a pivot pin of a tilt cylinder. The front frame may further have two substantially identical lift structures located at sides of the central tilt structure, the lift structures being configured to receive spaced apart lift arms. The front frame may additionally have an axle mounting pad connected at a base of each of the lift structures and configured to engage a front axle of the articulated machine, and a bearing bore located adjacent the axle mounting pad and configured to receive a pivot pin of a steering cylinder.

### TECHNICAL FIELD

The present disclosure relates generally to a steering linkage arrangement and, more particularly, to a steering linkage arrangement for an articulated mobile machine.

### BACKGROUND

Articulated mobile machines, for example haul trucks, scrapers, wheel loaders, motor graders, and other machines, generally include a tool (e.g., a non-engine) section and a tractor (e.g., an engine) section that are coupled together by way of a hitch. A conventional hitch is configured to swivel about an articulation joint and thereby allow the tool section to move in a direction different from the tractor section. This articulation facilitates steering of the machine.

An exemplary mobile machine is disclosed on page 3 of a product brochure entitled “988H Wheel Loader” that published in 2010 and can be found at the internet website: http://xml.catmms.com/servlet/ImageServlet?imageId=C609127&imageType=2. In this brochure, the machine (known commonly as a 6-bar machine) is shown with a single and centrally-located box boom that is pivotally connected to a front tool section. The machine also includes a pair of hydraulic cylinders located at opposing sides of an articulation hitch. The hydraulic cylinders are connected at a forward end near an axle of the front tool section and outboard of the box boom, and at a rear end near the articulation hitch. The hydraulic cylinders are used to pivot the front tool section relative to a rear tractor section.

Another exemplary mobile machine is disclosed on page 4 of a product brochure entitled “990H Wheel Loader” that published in 2012 and can be found at the internet website: http://xml.catmms.com/servlet/ImageServlet?imageId=C743073&imageType=2. In this brochure, the machine (known commonly as a Z-bar machine) is shown with a boom consisting of dual, spaced-apart lift arms that are pivotally connected to a front tool section. The machine also includes a pair of hydraulic cylinders located at opposing sides of an articulation hitch. The hydraulic cylinders are connected at a forward end near the articulation hitch, and at a rear end near an axle in an open structure of a rear tractor section.

The rear tractor section of the 6-bar machine has proven to be durable in high-stress applications due to its generally closed-in configuration. The closed-in configuration in the rear tractor section of the 6-bar machine may be possible because the associated steering cylinders do not require an open structure for attachment. The steering linkage of the 6-bar machine has historically been preferred by customers over the steering linkage of the Z-bar machine, because steering loads may be smaller and more controllable with the associated outboard-location of the steering cylinders. In contrast, the lift arm cost, durability, productivity, and/or strength of the Z-bar machine linkage may be superior to the box boom linkage of the 6-bar machine, in some applications. Due to space constraints associated with the dual, spaced-apart lift arms of the Z-bar linkage, however, it has not previously been possible to apply the rear tractor section and steering linkage of the 6-bar machine to a Z-bar machine.

The disclosed steering linkage arrangement is directed to overcoming one or more of the problems set forth above and/or other problems of the prior art.

### SUMMARY

In one aspect, the present disclosure is directed to a front frame for use with steering linkage of an articulated machine. The front frame may include a central tilt structure having two spaced apart parallel plates, at least one web member disposed between and connecting the parallel plates, and an articulation hitch hinge component connected to the at least one web member at a base of the parallel plates. The front frame may also include mounting lugs connected to the at least one web member at a point opposite the base. The mounting lugs may be configured to receive a pivot pin of a tilt cylinder. The front frame may further include two substantially identical lift structures located at opposing sides of the central tilt structure. The lift structures may be configured to receive spaced apart lift arms. The front frame may additionally include an axle mounting pad connected at a base of each of the lift structures and configured to engage a front axle of the articulated machine, and a bearing bore located adjacent the axle mounting pad and configured to receive a pivot pin of a steering cylinder.

In another aspect, the present disclosure is directed to a steering linkage arrangement. The steering linkage arrangement may include a front frame having axle mounting pads configured to engage a front axle of an articulated machine, and parallel lift arms pivotally connected at first ends to the front frame and configured to connect to a work tool of the articulated machine at opposing second ends. The steering linkage arrangement may further include a pair of lift cylinders connected between sides of the front frame and the lift arms, a bell crank connected at a center to the parallel lift arms and configured to connect to the work tool, and a tilt cylinder pivotally connected to a center of the front frame and an end of the bell crank. The steering linkage arrangement may also include a pair of steering cylinders connected at first ends to the front frame adjacent the axle mounting pads and configured to connect to a rear frame at second ends. The pair of steering cylinders may be located outboard of the front frame and below the parallel lift arms.

### BRIEF DESCRIPTION OF THE DRAWINGS

FIG. 1 is an isometric illustration of an exemplary disclosed mobile machine; and

FIG. 2 is an isometric illustration of an exemplary disclosed front frame that may be used in conjunction with the mobile machine of FIG. 1.

### DETAILED DESCRIPTION

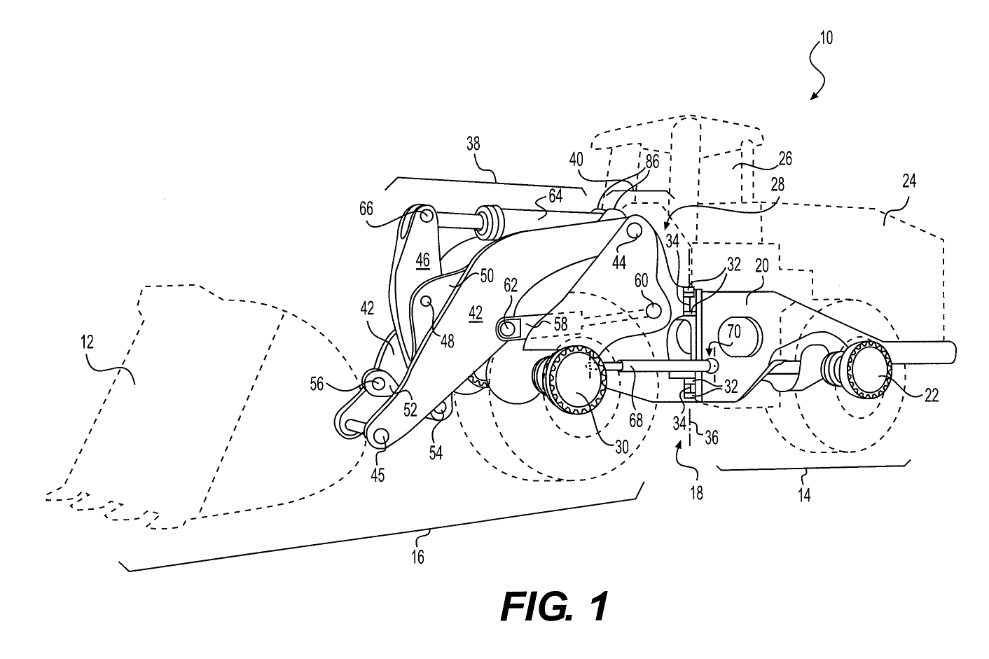

FIG. 1 illustrates an exemplary mobile machine 10. Machine 10, in the disclosed example, is an earth-moving machine such as a wheel loader. Machine 10 may be configured to load a work tool 12 with material at a first location, transport the material from the first location to a second location, and unload the material from work tool 12 at the second location. It is contemplated, however, that machine 10 may embody another type of mobile machine, if desired, such as a scraper, a haul truck, a motor grader, or another machine known in the art. It is also contemplated that machine 10 may be used for activities other than transporting earthen material. Machine 10 may be an articulated machine having a tractor section 14 operatively connected to a tool section 16 by an articulation hitch 18.

Tractor section 14, in the disclosed embodiment, is located at a rear of machine 10 and configured to support a power source. Specifically, tractor section 14 may include a rear frame 20, a rear axle 22, a powertrain 24, and an operator station 26. Rear frame 20 may rotatably receive rear axle 22 and be configured to support powertrain 24 and operator station 26. Powertrain 24 may be configured to drive rear axle 22 and provide electrical and/or hydraulic power to other components of machine 10. Operator station 26 may facilitate manual control of machine 10.

Tool section 16 may include a front structures assembly 28 that supports work tool 12 at the front end of machine 10. In the disclosed example, work tool 12 is a loader bucket that is vertically supported by a front axle 30, such that work tool 12 may be raised, lowered, and tilted relative to a ground surface. It should be noted, however, that other types of work tools 12 may alternatively be utilized in connection with machine 10. In some embodiments, front axle 30 may also be driven by powertrain 24, for example via hitch assembly 18. In these embodiments, front axle 30 may be substantially identical to rear axle 22.

Hitch assembly 18 may be an assembly of components that cooperate to connect tractor section 14 with tool section 16, while still allowing some relative rotational movement therebetween. In particular, hitch assembly 18 may include a pivot joint having separate hinge components 32 that are rigidly connected to each of tractor and tool sections 14, 16, and one or more pivot pins 34 that are received within and join hinge components 32. With this configuration, each of hinge components 32, along with the connected portions of tractor and tool sections 14, 16, may swivel about pivot pins 34, thereby allowing machine 10 to steer about a vertical axis 36.

Front structures assembly 28 may include structural components that support movement of work tool 12 and steering of machine 10. In particular, front structures assembly 28 may include a tool linkage arrangement 38 that is pivotally mounted to a front frame 40. Front frame 40, in turn, may be rigidly mounted to front axle 30 and pivotally joined to rear frame 20 at articulation hitch 18.

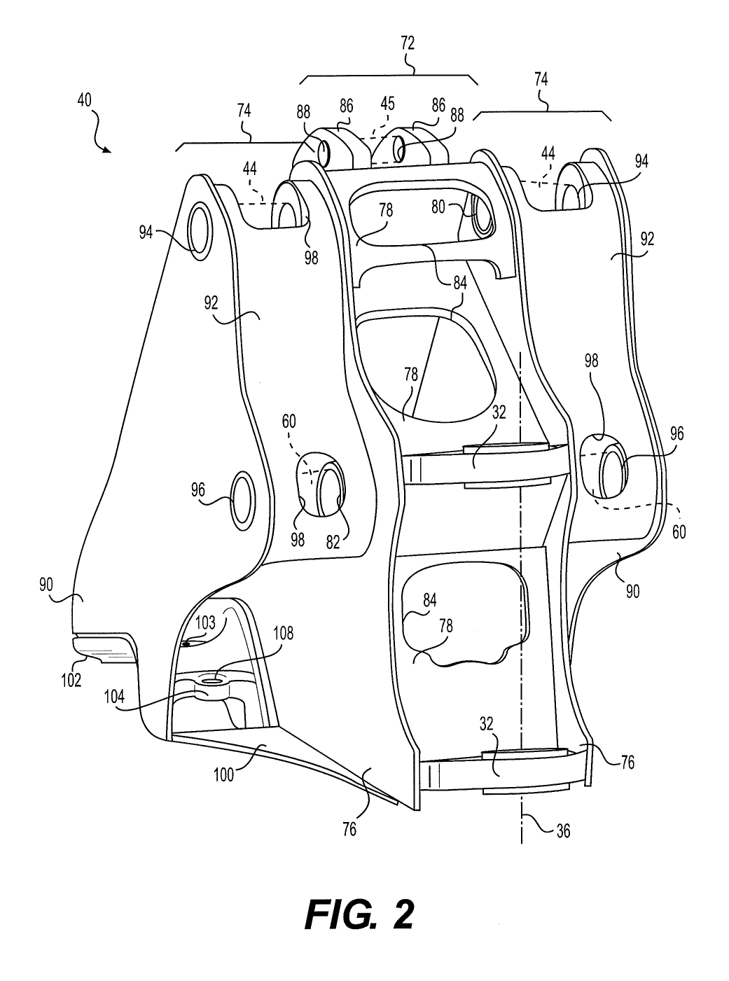

As shown in FIG. 1, tool linkage arrangement 38 may include, among other things, a pair of spaced apart generally plate-like lift arms 42, a bell crank 46, and a tilt link 52. Lift arms 42 may be pivotally connected at a proximal end to front frame 40 via a pivot pin 44, and at a distal end to work tool 12 via an addition pivot pin 45. Bell crank 46 may be generally centered between and centrally connected to lift arms 42 at a pivot pin 48, for example, via mounting lugs 50 that are integral with lift arms 42. Tilt link 52 may be connected between a distal end of bell crank 46 and work tool 12 via two different pivot pins 54, 56, respectively. A pair of substantially identical hydraulic cylinders 58 (only one shown in FIG. 1) may be connected at a first end to front frame 40 via a first pivot pin 60, and at an opposing second end to lift arms 42 via a pivot pin 62. An additional hydraulic cylinder 64 may be located between lift arms 42, connected at a first end to front frame 40 via a pivot pin 45 (shown only in FIG. 2) and at an opposing second end to bell crank 46 via a pivot pin 66. With this arrangement, extensions and retractions of hydraulic cylinders 58 may function to raise and lower lift arms 42, respectively, along with connected work tool 12, bell crank 46, and link 52. Similarly, extension and retraction of hydraulic cylinder 64 may function to rack and dump work tool 12, respectively. This arrangement may be recognized as similar to the linkage of a Z-bar machine.

One or more hydraulic cylinders (or other steering actuators) 68 may connect rear frame 20 to front frame 40, and function to pivot tool section 16 relative to tractor section 14. In the disclosed embodiment, two hydraulic cylinders 68 are utilized for this purpose; one located at each side of hitch assembly 18. Each hydraulic cylinder 68 may be connected at a rod-end to rear frame 20 adjacent hitch assembly 18, and at a head-end to front frame 40 adjacent front axle 30. With this configuration, a retraction of hydraulic cylinder 68 located at a left side of machine 10 (relative to an operator's perspective), combined with an extension of hydraulic cylinder 68 located at a right side of machine 10 may function to articulate tool section 16 counterclockwise relative to tractor section 14 (as viewed from above machine 10). The opposite may also be true.

Each hydraulic cylinder 68 may be connected to rear frame 20 and to front frame 40 by way of vertically-oriented pivot pins (not shown). In particular, the head-end of hydraulic cylinder 68 may be connected to rear frame 20 via a vertical pivot pin that passes through a mounting arm 70. Mounting arm 70 may extend forward and outward from a front corner of rear frame 20, at a height about equal to the height of an axis of front axle 30 (e.g., equal to or just higher than the axis, but lower than a hub portion of front axle 30). In one embodiment, the pivot pin at the head-end of hydraulic cylinder 68 maybe generally aligned with axis 36 of hitch assembly 18 in a fore/aft direction of machine 10. The rod-end of hydraulic cylinder 68 may be similarly connected to front frame 40 via a vertical pivot pin that is located just rearward of front axle 30 (e.g., rearward of the axis of front axle 30, but within a hub diameter of front axle 30). Hydraulic cylinders 68 may be generally horizontally oriented and located in general transverse alignment with lift arms 42.

An exemplary embodiment of front frame 40 is shown in FIG. 2. As can be seen in this figure, front frame 40 may include, among other things, a central tilt structure 72, and lift structures 74 connected to opposing sides of central tilt structure 72. Central tilt structure 72 may be configured to support tilting of work tool 12 (referring to FIG. 1), while lift structures 74 may be configured to support lifting of work tool 12. Central tilt structure 72 may be rigidly connected to lift structures 74, for example by welding.

Central tilt structure 72 may include two parallel plates 76 that are joined to each other at least one intermediate web member 78 to form a generally hollow or box-like enclosure. Each of plates 76 and web members 78 may be fabricated from steel stock having about the same thickness, and joined to each other via welding. Plates 76 may be generally triangularly shaped, and have a first bearing bore 80 located at an apex to receive pivot pins 44, and a second bearing bore 82 located at a rear base corner near an upper one of hinge components 32 to receive pivot pins 60. Hinge components 32 may extend rearward from web members 78, between plates 76. One or more holes 84 may be formed within web members 78 to reduce a weight and/or cost of machine 10, while also allowing debris to fall through central tilt structure 72 to the ground surface below. Holes 84 may also provide service access to components (e.g., hoses, fasteners, wiring harnesses, etc.) that may be housed within central tilt structure 72.

A pair of mounting lugs 86 may be integral with central tilt structure 72, and extend upward away from web members 78. Mounting lugs 86 may be located higher than (i.e., further away from the ground surface upon which machine 10 is operating) and forward of bearing bores 80. Mounting lugs 86 may themselves each include a bearing bore 88 configured to receive pivot pin 45 that is connected to the head-end of hydraulic cylinder 64. With this configuration, central tilt structure 72 may support tilting of work tool 12 caused by extension and retraction of hydraulic cylinder 64.

Each of lift structures 74 may include an outer plate 90 that is separated from and joined to plates 76 of central tilt structure 72 via at least one intermediate web member 92. Plates 90 may be generally parallel with plates 76, joined to web members 92 via welding, and generally triangularly shaped. Like plates 76, plates 90 may each include a bearing bore 94 at its apex that is configured to receive pivot pin 44, and a bearing bore 96 at its rear base corner that is configured to receive pivot pin 60. Web members 92 may include one or more cutouts 98 that provide clearance for lift arms 42 and/or hydraulic cylinders 58. One or more gussets 100 may be provided to connect outer plates 90 and/or web members 92 of lift structure 74 to plate 76 of central tilt structure 72.

An axle mounting pad 102 may be located at a lower front corner of each lift structure 74 and used to connect front frame 40 to front axle 30. Axle mounting pad 102 may be connected to outer plate 90 of lift structure 74, web members 92, and/or plate 76 of central tilt structure 72. Axle mounting pad 102 may be connected to any one or all of these components, for example, by welding. Each axle mounting pad 102 may be configured to rest on top of a generally flat upper surface of front axle 30, and include a plurality of holes 103 (only one shown) that accommodate fasteners clamping the two components together.

An adapter 104 may be formed within a lowest portion of each lift structure 74 and configured to receive the vertical pivot pin of a corresponding hydraulic cylinder 68. Adapter 104 may be integral with axle mounting pad 102 and, in the disclosed embodiment, formed through a casting process and later joined to lift structure 74 via welding. Adapter 104 may have a vertically oriented bearing bore 106 configured to receive the pivot pin of hydraulic cylinder 68. Bearing bore 106 may be located immediately rearward of axle mounting pad 102, just below axle mounting pad 102, but above the axis of front axle 30.

### INDUSTRIAL APPLICABILITY

The disclosed steering linkage arrangement may be applicable to any articulated mobile machine where improved steering and durability is desired. However, the disclosed steering linkage arrangement may be particularly beneficial to mobile machines known as Z-bar machines, where packaging difficulties associated with parallel lift arms normally preclude the use of front-located steering cylinders. The disclosed steering linkage arrangement may be adapted to the tool linkage of a Z-bar machine via a unique front structures assembly, which locates the corresponding steering cylinders low on the machine, near the front axle, and out of the way of the associated lift arms. With this arrangement, the historically durable rear tractor section and highly desirable steering linkage of a 6-bar machine may be used together with the low-cost, durable Z-bar tool linkage.

It will be apparent to those skilled in the art that various modifications and variations can be made to the disclosed steering linkage arrangement without departing from the scope of the disclosure. Other embodiments of the steering linkage arrangement will be apparent to those skilled in the art from consideration of the specification and practice of the steering linkage arrangement disclosed herein. It is intended that the specification and examples be considered as exemplary only, with a true scope being indicated by the following claims and their equivalents.

What is claimed is:

1. A front frame for use with steering linkage of an articulated machine, comprising:
a central tilt structure including:
two spaced apart parallel plates;
at least one web member disposed between and connecting the parallel plates;
an articulation hitch hinge component connected to the at least one web member at a base of the parallel plates; and
mounting lugs connected to the at least one web member at a point opposite the base, the mounting lugs configured to receive a pivot pin of a tilt cylinder;
two substantially identical lift structures located at opposing sides of the central tilt structure, the lift structures configured to receive spaced apart lift arms;
an axle mounting pad connected at a base of each of the lift structures and configured to engage a front axle of the articulated machine; and
a bearing bore located adjacent the axle mounting pad and configured to receive a pivot pin of a steering cylinder.

2. The front frame of claim 1, wherein the lift arms are plate-like and the lift structures each include a bearing bore configured to receive a pivot pin that passes through an end of a corresponding one of the lift arms.

3. The front frame of claim 1, wherein the parallel plates are generally triangular, and the mounting lugs are located at apexes of the parallel plates.

4. The front frame of claim 1, wherein the bearing bore and the axle mounting pad are formed as a single cast component.

5. The front frame of claim 4, wherein one of the single cast component is welded to each of the lift structures.

6. The front frame of claim 1, wherein each of the lift structures includes a bearing bore configured to receive a different lift cylinder associated with the lift arms.

7. The front frame of claim 1, wherein each of the lift structures is generally triangularly shaped.

8. The front frame of claim 1, wherein the axle mounting pad includes holes configured to receive fasteners that clamp the front frame to the front axle.

9. The front frame of claim 1, wherein the bearing bore is located outward of the lift arms and rearward of the axle mounting pad.

10. The front frame of claim 9, wherein the bearing bore is further located lower than the axle mounting pad when connected to the articulated machine, and higher than an axis of the front axle.

11. A steering linkage arrangement, comprising:
a front frame having axle mounting pads configured to engage a front axle of an articulated machine;
parallel lift arms pivotally connected at first ends to the front frame and configured to connect to a work tool of the articulated machine at opposing second ends;
a pair of lift cylinders connected between sides of the front frame and the lift arms;
a bell crank connected at a center to the parallel lift arms and configured to connect to the work tool;
a tilt cylinder pivotally connected to a center of the front frame and an end of the bell crank; and
a pair of steering cylinders connected at first ends to the front frame adjacent the axle mounting pads and configured to connect to a rear frame at second ends, the pair of steering cylinders located outboard of the front frame and below the parallel lift arms.

12. The steering linkage arrangement of claim 11, wherein the steering cylinders are generally aligned in a transverse direction with the parallel lift arms.

13. The steering linkage arrangement of claim 12, wherein the steering cylinders are located at about the same height as the axle mounting pads.

14. The steering linkage arrangement of claim 13, wherein the first end of each steering cylinder is located immediately rearward of the axle mounting pads.

15. The steering linkage arrangement of claim 14, further including an articulation hitch configured to connect the front frame to the rear frame, wherein the second end of each steering cylinder is configured to connect to the rear frame adjacent the articulation hitch.

16. The steering linkage arrangement of claim 15, further including arms configured to extend forward and outward from front corners of the rear frame, wherein the second ends of the steering cylinders are connected to the rear frame via the arms.

17. The steering linkage arrangement of claim 16, further including pivot pins that connect the second ends of the steering cylinders to the arms, wherein the pivot pins are generally aligned with an axis of the articulation hitch.

18. The steering linkage arrangement of claim 11, wherein:
the front frame further includes bearing bores configured to receive pivot pins that connect the first ends of the steering cylinders to the front frame; and
each of the bearing bores and one of the axle mounting pads are cast as a single integral component that is welded to the front frame.

19. A mobile machine, comprising:
a rear axle;
a rear frame mounted to the rear axle;
a power source supported by the rear frame;
an operator station supported by the rear frame;
a work tool;
a front axle;
a front structures assembly mounted to the front axle and having a parallel lift arms that are operatively connected to the work tool;
an articulation hitch connecting the front structures assembly to the rear frame; and
two steering actuators located at opposing sides of the articulation hitch, each having a first end connected to the rear frame at a location adjacent the articulation hitch and a second end connected to the front structures assembly at the front axle.

20. The mobile machine of claim 19, wherein the second end of each steering actuator is connected to a front frame of the front structures assembly at a location below a hub periphery of the front axle and above an axis of the front axle, in transverse alignment with a corresponding one of the parallel lift arms, and at a location immediately behind the front axle.
